(19) United States
(12) Patent Application Publication
(10) Pub. No.: US 2009/0204956 A1
(43) Pub. Date: Aug. 13, 2009

(54) MULTIPLE-MODE SOFTWARE LICENSE ENFORCEMENT

(75) Inventors: Steven J. Branda, Rochester, MN (US); Surya V. Duggirala, Eagan, MN (US); Bhushan K. Lokhande, Rochester, MN (US); Timothy P. Pickett, Rochester, MN (US); John J. Stecher, Rochester, MN (US)

Correspondence Address: IBM CORPORATION, 3605 HIGHWAY 52 NORTH, DEPT. 917, BUILDING 006-1, ROCHESTER, MN, 55901-7829, US

(73) Assignee: INTERNATIONAL BUSINESS MACHINES CORPORATION, Armonk, NY (US)

(21) Appl. No.: 12/028,234

(22) Filed: Feb. 8, 2008

(51) Int. Cl. G06F 9/44

(52) U.S. Cl. 717/168

(57) ABSTRACT

A computer implemented method, for multiple-mode software license enforcement on a client, including encoding in the software at least one predetermined event that occurs prior to a validation of the software program and encoding it with different functional states. The software's resulting modification may be of reduced or increased functionality or both reduced and increased functionality. The predetermined events may be the elapsing of a predetermined length of time, the entry of a valid registration key or an act of validating. Each of these events may take place a multiple number of times.

### BACKGROUND

This invention relates to software licenses. More specifically, it relates to a multiple-mode client for server-based software licenses.

A software product is a package of items including a software program that is typically on a computer readable medium, documentation and a license to operate the software program. The software provider's licensing machine is known as the server or the license server. The software program resides on one or more computer devices or media that is known as the client. The client interacts with the server and vice versa by transmission of information. Software licensing may be enforced by requiring a purchaser of the software product to register their product with the software provider. This registration may be done in a number of fashions, for instance filling out a registration card and sending it in via postal mail, calling a sales representative, or registering over an Internet connection between the client and the server.

Once this initial contact is made, the software provider will confirm the software use is proper, resulting in “validation.” Once the validation has occurred, the software product is “validated.” The process of attempting to achieve this validated state is known as “validating.” When the software product is not validated, it is in a state known as “non-validated.” Once validated, the software product may become non-validated again. For example, if the software product is provided on a subscription basis, then after the subscription period ends, a renewal fee may be required. The software provider would then want to set the software product state to non-validated and the recently non-validated software product would thus need to go through validating again to become validated.

Upon reaching a validated state, full functionality of the software is typically granted to the user. However, prior to validation, the software may have full or partial functionality. In such a case, a user who understands the license registration and validation scheme, may attempt to circumvent the validation process by simply never allowing the client to connect to the license server. This could then allow the software to function in contravention to any licensing agreement. Additionally, some software products come with trial-period licensing schemes, which allow the software product to functional fully for a predetermined period of time. This time-based limitation may be circumvented by reinstalling the software program or manipulating the client's system time prior to the installation of the software program.

### BRIEF SUMMARY

A computer implemented method, for multiple-mode software license enforcement on a client, including encoding in the software at least one predetermined event that occurs prior to a validation of the software program and encoding it with different functional states. The software's resulting modification may be of reduced or increased functionality or both reduced and increased functionality. The predetermined events may be the elapsing of a predetermined length of time, the entry of a valid registration key or an act of validating. Each of these events may take place a multiple number of times.

### BRIEF DESCRIPTION OF THE DRAWINGS

FIG. 1 is a flowchart showing the server contact and the application of a mode of license enforcement to the client software.

FIG. 2 is a flowchart showing an alternative embodiment, allowing for the software user to register the software without use of client-server interaction.

FIG. 3 is a flowchart showing an alternative embodiment, allowing for the software provider to enforce a different mode once a predetermined amount of time has elapsed.

FIG. 4 is a conceptual diagram of a computer system.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Turning to the present invention, once a software product has been purchased, the software licensing and its validation process may be circumvented. The software user may prevent registration and validation by preventing the client from connecting to the server by, for instance, disabling the client's Internet connection or setting up a firewall rule. Because the client cannot contact the server, the software often will simply continue with full or adequate partial functionality and perform under the assumption that network connectivity will be established eventually. Consequently, the software user is able to receive full or adequate partial functionality of the software without registration and validation.

In one embodiment of the invention, the software may function in various modes, or functional states, which correspond to the occurrence of various predetermined events as dictated by the software, provide. These multiple modes could range in differing degrees of functionality from none to full as permitted on the software. The different resulting functionality will continue until the server can be reached. One implementation of this embodiment would be to have at least one predetermined event that occurs prior to a validation of the software program. The occurrence of this predetermined event would cause an implementation of at least one of three different modes of functionality. Each of these levels of functionality is available prior to validation. The predetermined events may be, for example, the elapsing of a predetermined length of time, the entry of a valid registration key, or an act of validating. Any of these predetermined events may occur a multiple number of times. Further, other predetermined events are within the scope of the present invention.

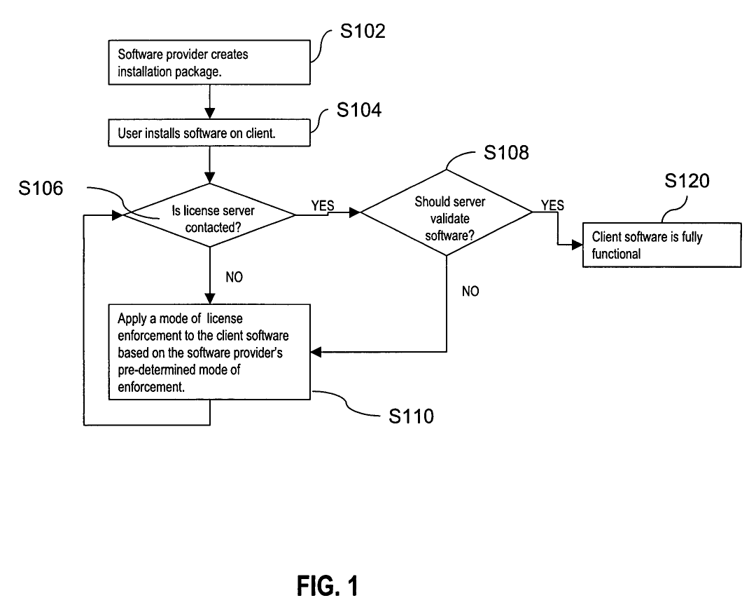

FIG. 1 is a flowchart demonstrating an embodiment of the invention. In step S102, the software provider creates a software installation package. This package contains the installation software that enables use of the software package on the client. The software is purchased, or transferred to the user, who in S104 then installs the software on the client. After installation, the client should try to contact the license server in S106. If the contact is successful, the license server will perform actions to determine whether or not to validate the software in S108. This could entail checking the serial number or other identifying information sent by the client, or inquiring the user about other information. If the validation is successful, the client software is then enabled to be fully functional, as in S120.

On the other hand, if the license server does not validate the software, at S108, for example, due to an incorrect serial number being entered, the license server will apply a mode of license enforcement to the client software, as in S110. Similarly, if the license server was not contacted in S106, a mode of license enforcement will be applied.

An example of multiple modes of enforcement may be a choice between hard, medium and soft modes. This ranges from no functionality to complete functionality. The proper mode would be determined at S102, by the software provider when she is creating the installation package. The hard mode may be that the software would halt higher functions of the software. Higher functions are the high-value, critical functions of software that an ordinary software user would consider important in using the software. Examples are printing, copying or sending files associated with the software. A medium mode may be a combination of an increase and a decrease of functionality. For instance, the medium mode may allow higher functions to continue, but disable some of the features of the software, or add watermarks to any visual outputs such as images or documents saying, for example, “Trial Software,” The soft mode may allow full functionality, but create an activity log of the user. Other modes could include full functionality or no functionality of the software products or combination of any of the aforementioned modes. Additionally, other modes reflecting changing of other functionality may be contemplated.

These entries may be used subsequently as a means to catch license misuse or retroactively account for license use. For instance, the user could try to reset the system time to grant the client more time in a time-based trial period for use of the software. The log would allow for retroactive enforcement, if it is ever recovered or eventually sent to the license server.

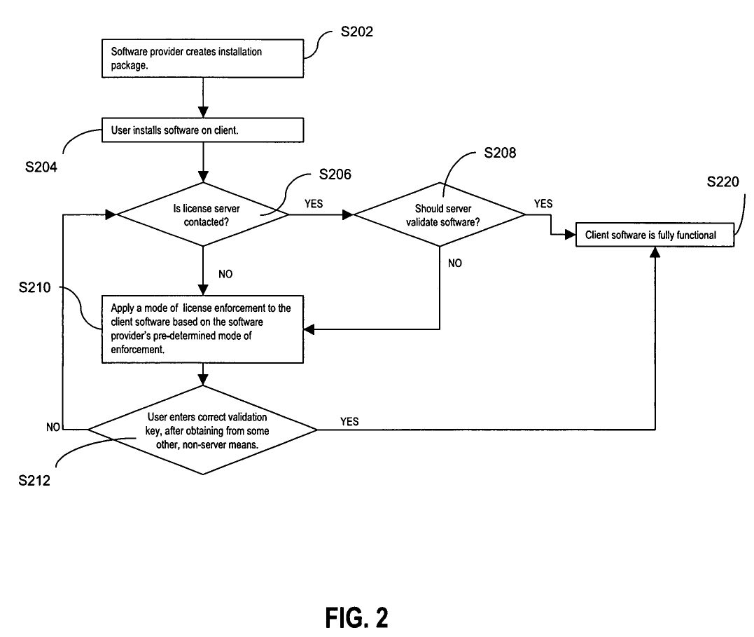

In another embodiment of the invention, the user could receive validation for his software license independent of establishing a client-server connection, as denoted in FIG. 2. The flowchart is similar to FIG. 1, with the exception that after S210, when a mode of license enforcement is applied to the client software, the user has the opportunity to enter a correct validation key, allowing for the client software to become fully functional at S220. S202 through S208 and S220 are similar to the corresponding states of S102 through S108 and S120, respectively. If no successful validation key is entered, then the mode of license enforcement is maintained, and attempts to contact the license server resume at S206.

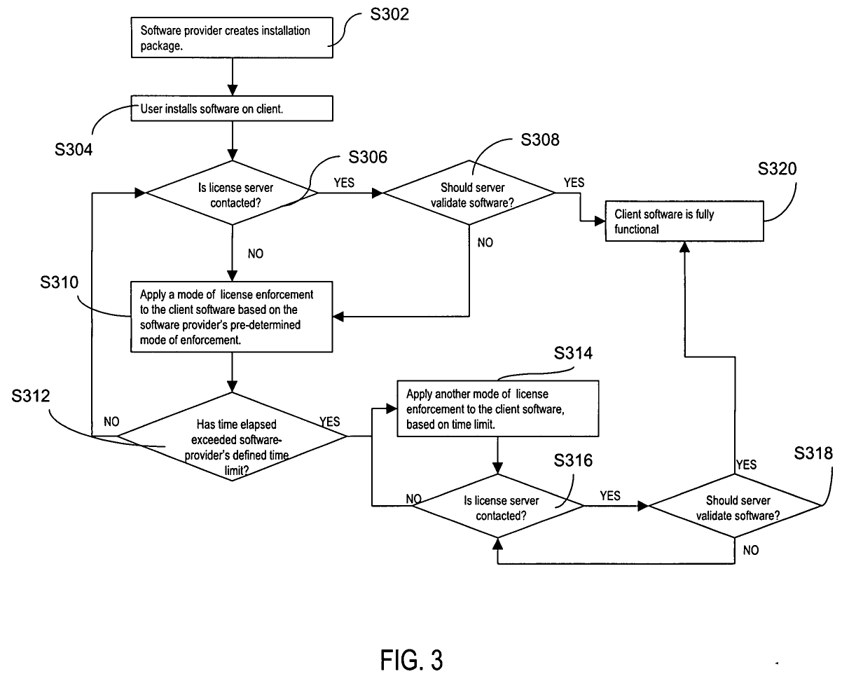

In yet another embodiment of the invention denoted in FIG. 3, the software provider may wish to change the enforcement mode after an amount of time has passed and there has still not been any client-server contact. FIG. 3 is similar to FIG. 2: S302 through S310 and S320 are similar to the corresponding states of S202 through S210 and S220, respectively. However, in this embodiment, when a predetermined time has passed (S312), then a different enforcement mode is applied to the software at S314. A check on whether the license server has been contacted is performed in S316. If there is a successful contact, then the server will validate the software as in S318 and the client will be fully functional again as in S320. If the license server is still not contacted though, the same enforcement mode is applied as in S314 and the license server is checked continuously (S316). An alternative to this embodiment may have a different mode being enforced in S314 on a subsequent iteration after validating fails to achieve validation.

Another embodiment of the invention may include enforcement of these multiple modes after successful validation with the license server. For instance, the software provider may wish to grant a license for only a year on a subscription basis. After the year is up, multiple modes of license enforcement may take place again until successful re-validation takes place.

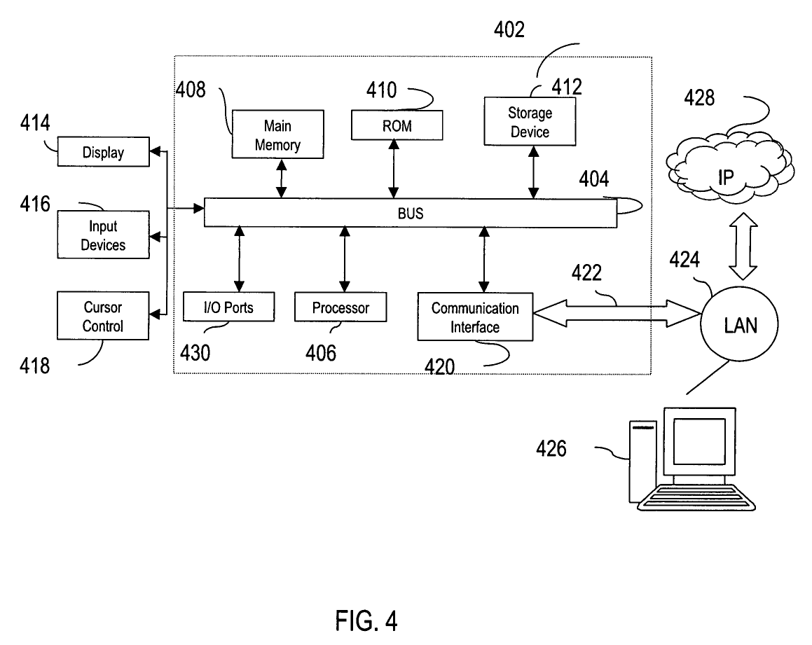

FIG. 4 illustrates a computer system (402) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (404) or other communication mechanism for communicating information and a processor (406) coupled with bus (404) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (406). In addition, main memory (408) may be used for storing temporary variables or other intermediate information during execution of instructions to be executed by processor. The computer system further includes a read only memory (ROM) 410 or other static storage device (e.g., programmable ROM (PROM), erasable PROM (EPROM), and electrically erasable PROM (EEPROM)) coupled to bus 404 for storing static information and instructions for processor. A storage device (412), such as a magnetic disk or optical disk, is provided and coupled to bus for storing information and instructions. This storage device is an example of a computer readable medium, upon which the program may be encoded.

The computer system also includes input/output ports (430) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method of allowing additional tail call optimizations as described with reference to FIG. 1. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct memory access (DMA) bus). The computer system may additionally include a compact disc reader, a compact disc reader-writer unit, or a compact disc jukebox, each of which may be connected to the same device bus or another device bus.

The computer system may be coupled via bus to a display (414), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (416) and a cursor control (418), for communicating information and command selections to processor (406). Such command selections can be implemented via voice recognition hardware and/or software functioning as the input devices (416). The cursor control (418), for example, is a mouse, a trackball, cursor direction keys, touch screen display, optical character recognition hardware and/or software, etc., for communicating direction information and command selections to processor (406) and for controlling cursor movement on the display (414). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (420) provides a two-way data communication coupling to a network link (422) that may be connected to, for example, a local network (424). For example, the communication interface (420) may be a network interface card to attach to any packet switched local area network (LAN). As another example, the communication interface (420) may be an asymmetrical digital subscriber line (ADSL) card, an integrated services digital network (ISDN) card or a modem to provide a data communication connection to a corresponding type of telephone line. Wireless links may also be implemented via the communication interface (420). In any such implementation, the communication interface (420) sends and receives electrical, electromagnetic or optical signals that carry digital data streams representing various types of information.

Network link (422) typically provides data communication through one or more networks to other data devices. For example, the network link may provide a connection to a computer (426) through local network (424) (e.g., a LAN) or through equipment operated by a service provider, which provides communication services through a communications network (428). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention. Additionally, a person skilled in the art will readily be able to implement the source code and means of performing this optimization.

What is claimed is:

1. A method for multiple-mode software license enforcement on a software program produced by a software provider, comprising:
encoding the software program with at least one predetermined event that occurs prior to a validation of the software program;
encoding the software program with at least three different functional states, each functional state corresponding to a different level of functionality of the software program, and each of which is implementable prior to the validation of the software program;
detecting the at least one predetermined event; and
responsive to the detecting, and prior to the validation of the software program, modifying the level of functionality of the software program to correspond to one of the functional states from the at least three different functional states.

2. The method of claim 1, further comprising:
validating the software program;
providing a post-validation predetermined event that occurs after validation of the software program;
responsive to the post-validation predetermined event, modifying the level of functionality of the software program to correspond to one of the functional states from the at least three different functional states.

3. The method of claim 1, wherein the predetermined event is the elapsing of a predetermined length of time.

4. The method of claim 1, wherein the predetermined event is an entry of a valid registration key.

5. The method of claim 1, wherein the predetermined event is an act of validating.

6. The method of claim 1, wherein the predetermined event occurs a multiple number of times.

7. The method of claim 1, wherein the encoding of the predetermined event includes encoding a plurality of different predetermined events that occur prior to the validation of the software program.

8. The method of claim 1, wherein one of the functional states, includes an increase in functionality of the software program.

9. The method of claim 1, wherein one of the functional states, includes a decrease in functionality of the software program.

10. The method of claim 1, wherein one of the functional states, includes both an increase and decrease in functionality of the software program.

11. The method of claim 1, wherein the functional state is selected from the group consisting of a soft, a medium and a hard mode.

12. A computer program product for multiple-mode software license enforcement on a client, the computer program product comprising:
a computer usable medium having computer usable program code embodied therewith, the computer usable program code comprising:
instructions to encode the software program with at least one predetermined event that occurs prior to a validation of the software program;
instructions to encode the software program with at least three different functional states, each functional state corresponding to a different level of functionality of the software program, and each of which is implementable prior to the validation of the software program;
instructions to detect the at least one predetermined event; and
responsive to the detecting, and prior to the validation of the software program, modifying the level of functionality of the software program to correspond to one of the functional states from the at least three different functional states.

13. The computer program product of claim 12, further comprising
instructions for validating the software program;
instructions for providing a post-validation predetermined event that occurs after validation of the software program;
responsive to the post-validation predetermined event, instructions to modify the level of functionality of the software program to correspond to one of the functional states from the at least three different functional states.

14. The computer program product of claim 12, wherein the predetermined event includes at least one of the elapsing of a predetermined length of time, an entry of a valid registration key, and an act of validating.

15. The computer program product of claim 12, wherein the predetermined event occurs a plurality of times.

16. The computer program product of claim 12, wherein the instructions to encode the predetermined event includes more than one predetermined event that occurs prior to a validation of the software program.

17. The computer program product of claim 12, wherein one of the functional states of the software product either increases the functionality to the software product or decreases the functionality from the software product.

18. The computer program product of claim 12, wherein one of the functional states of the software product both increases the functionality from the software product and decreases the functionality from the software product.

19. A computer system comprising:
a processor;
a memory operatively coupled to the processor;
a storage device operatively coupled to the processor and memory; and
a computer program product for multiple-mode software license enforcement on a client, the computer program product comprising a computer usable medium storable in the storage device, and having computer usable program code embodied therewith, the computer usable program instructions comprising:
instructions to encode the software program with at least one predetermined event that occurs prior to a validation of the software program;
instructions to encode the software program with at least three different functional states, each functional state corresponding to a different level of functionality of the software program, and each of which is implementable prior to the validation of the software program;
instructions to detect the at least one predetermined event; and
responsive to the detecting, and prior to the validation of the software program, modifying the level of functionality of the software program to correspond to one of the functional states from the at least three different functional states.

20. The system of claim 19, further comprising
instructions for validating the software program;
instructions for providing a post-validation predetermined event that occurs after validation of the software program;
responsive to the post-validation predetermined event, instructions to modify the level of functionality of the software program to correspond to one of the functional states from the at least three different functional states.

21. The system of claim 19, wherein the predetermined event includes the elapsing of a predetermined length of time, or an entry of a valid registration key, or an act of validating.

22. The system of claim 19, wherein the predetermined event may occur a multiple number of times.

23. The system of claim 19, wherein the instructions to encode the predetermined event includes more than one predetermined event that occurs prior to a validation of the software program.

24. The system of claim 19, wherein one of the functional states of the software product either increases the functionality to the software product or decreases the functionality from the software product.

25. The system of claim 19, wherein one of the functional states of the software product both increases the functionality from the software product and decreases the functionality from the software product.
